(19) United States
(12) Patent Application Publication
(10) Pub. No.: US 2013/0154931 A1
(43) Pub. Date: Jun. 20, 2013

(54) MOUSE ASSEMBLY

(71) Applicant: QIANG CHEN, Shenzhen City (CN)

(72) Inventor: QIANG CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/426,630

(22) Filed: Mar. 22, 2012

(30) Foreign Application Priority Data
Dec. 14, 2011 (CN) 201110416925.0

(51) Int. Cl. G06F 3/033

(52) U.S. Cl. 345/163

(57) ABSTRACT

A mouse assembly includes a pad, a mouse, and a wrist support. The mouse is attached to an end of the pad. A first fastening member is attached to a top surface of the pad, and a second fastening member is attached to a bottom surface of the wrist support to adjustably engage with the first fastening member.

### BACKGROUND

1. Technical Field

The present disclosure relates to a mouse assembly.

2. Description of Related Art

A mouse pad generally includes a wrist support to support a wrist of a computer user. However, when the mouse is used, the relative position between the mouse and the mouse pad with the wrist support is usually changed, which is inconvenient for users. To solve the problem, the mouse and the mouse pad may be jointed, leading to a constant distance between the mouse and the wrist support, which is not flexible for different users.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a mouse assembly, wherein the mouse assembly includes a cushion block and a fastening member attached to the cushion block.

FIG. 2 is an inverted view of the cushion block and the fastening member of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

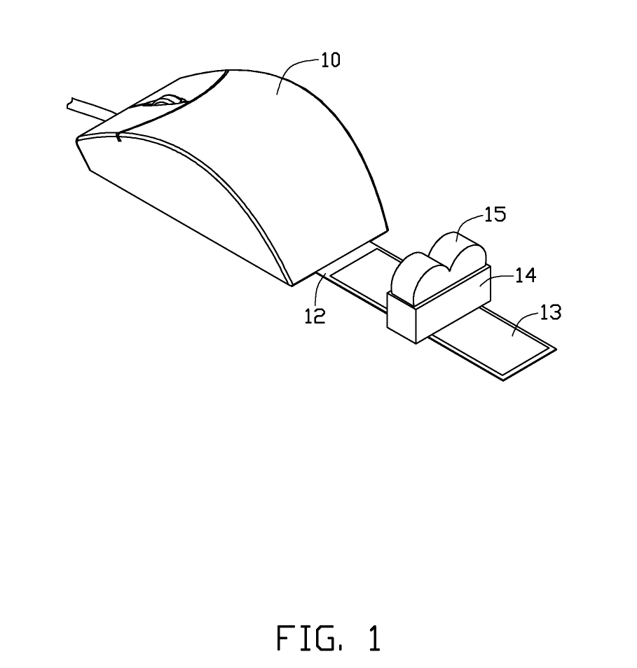

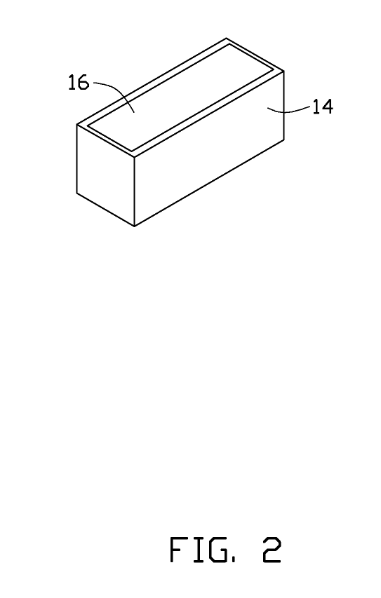

FIGS. 1 and 2, show an exemplary embodiment of a mouse assembly including a mouse 10, a pad 12, a cushion block 14, a wrist support 15, a fastener, such as one sold under trademark MAGIC TAPE, including a first fastening member 13, and a second fastening member 16. The mouse 10 is attached to an end of the pad 12. The first fastening member 13 is attached to a top surface of the pad 12 with glue or double-sided adhesive. The second fastening member 16 is engaged with the first fastening member 13, adnteh engaging position of the first fastening member 13 and second fastening member 16 is adjustable. The second fastening member 16 is attached to a bottom surface of the cushion block 14 with glue or double-sided adhesive. The wrist support 15 is attached to a top surface of the cushion block 14 with glue or double-sided adhesive.

The distance between the mouse 10 and the wrist support 15 may be adjusted to fit different users, by attaching and moving the second fastening member 16 to desired positions in relation to the first fastening member 13.

In other embodiments, the cushion block 14 is integrated as a part of the wrist support 15.

In other embodiments, the cushion block 14 is omitted, and the second fastening member 16 is attached to the wrist support 15.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mouse assembly comprising:
a mouse;
a pad attached to the mouse with an end;
a first fastening member attached on a top surface of the pad;
a wrist support; and
a second fastening member attached to a bottom surface of the wrist support to adjustably engage with the first fastening member.

2. The mouse assembly of claim 1, wherein the wrist support comprises a cushion block in a lower portion of the wrist support to attach to the second fastening member.

3. The mouse assembly of claim 1, wherein the fastening members are magic tapes.
